(19) United States
(12) Patent Application Publication
(10) Pub. No.: US 2013/0320043 A1
(43) Pub. Date: Dec. 5, 2013

(54) DOUBLE ACTING VALVE FOR LIQUID PUMPS

(71) Applicants: John J. McNulty, Broadview Heights, OH (US); Nick E. Ciavarella, Seven Hills, OH (US); Robert L. Quinlan, Stow, OH (US)

(72) Inventors: John J. McNulty, Broadview Heights, OH (US); Nick E. Ciavarella, Seven Hills, OH (US); Robert L. Quinlan, Stow, OH (US)

(73) Assignee: GOJO Industries, Inc., Akron, OH (US)

(21) Appl. No.: 13/791,450

(22) Filed: Mar. 8, 2013

Related U.S. Application Data
(60) Provisional application No. 61/653,059, filed on May 30, 2012.

(51) Int. Cl. B67D 7/58; G01F 11/00

(52) U.S. Cl. CPC B67D 7/64; F04B 39/1013; F04B 17/03; B67D 7/68
USPC 222/380; 222/325

(57) ABSTRACT

A refill unit includes a container for holding a liquid and a pump. The pump includes a housing that has one or more liquid inlets. In addition, the housing includes one or more liquid outlets. At least a portion of the liquid outlet(s) is made of a resilient material. A liquid chamber having a first volume and a second volume is located at least partially within the housing. A valve body having a protruding member and a valve seat is located within the housing. The protruding member acts as a one-way valve allowing fluid to flow from the container into the liquid chamber and preventing fluid from flowing out of the liquid chamber into the container. In addition, the liquid outlet contacts the valve seat to seal the outlet and flexes away from the valve seat to allow liquid under pressure to exit the liquid chamber.

### RELATED APPLICATIONS

This non-provisional utility patent application claims priority to and the benefits of U.S. Provisional Patent Application Ser. No. 61/653,059 filed on May 30, 2012 and entitled DOUBLE ACTING VALVE FOR LIQUID PUMPS. This application is incorporated herein by reference in its entirety.

### TECHNICAL FIELD

The present invention generally relates to dispensers, refill units, liquid pumps and valves for liquid pumps. More particularly, the present invention relates to double acting valves for use in liquid pumps, refill units and dispensers.

### BACKGROUND OF THE INVENTION

Liquid dispensers provide a user with a predetermined amount of liquid upon the actuation of the dispenser. They are known to dispense liquids, such as soaps, sanitizers, cleansers and disinfectants from a dispenser housing that uses a removable and replaceable cartridge containing the liquid. The pump mechanisms employed with such dispensers typically include a liquid inlet valve and a separate liquid outlet valve.

### SUMMARY

Refill units for foam dispensers are disclosed herein. One exemplary refill unit includes a container for holding a liquid and a pump in fluid communication with the container. The pump includes a housing that has one or more liquid inlets through the housing that are in fluid communication with the container. In addition, the housing includes one or more liquid outlets located through the housing. At least a portion of the liquid outlet(s) is made of a resilient material. A liquid chamber having a first volume and a second volume is located at least partially within the housing. A valve body having a protruding member and a valve seat is located within the housing. The protruding member acts as a one-way valve allowing fluid to flow from the container into the liquid chamber and preventing fluid from flowing out of the liquid chamber into the container. In addition, the liquid outlet contacts the valve seat to seal the outlet and flexes away from the valve seat to allow liquid under pressure to exit the liquid chamber.

Liquid pumps are disclosed herein. An exemplary liquid pump includes a housing that has one or more liquid inlets therethrough. A liquid chamber is located within the housing. The liquid chamber has a first volume and a second volume. The housing includes a liquid outlet that is at least partially formed by a resilient material. The resilient material is configured to deflect when the liquid chamber is pressurized and allow liquid to flow out of the housing. A valve body is located within the housing. The valve body has a resilient projection located proximate the liquid inlets. The resilient projection member prevents liquid from flowing out of the liquid chamber through the liquid inlets when there is a positive pressure in the liquid chamber. The valve body includes a valve seat. The valve seat engages the resilient liquid outlet member when there is a negative pressure in the liquid chamber and preventing fluid from flowing into the liquid chamber through the housing outlet.

Soap dispensers and refill units are also disclosed herein. In one exemplary embodiment, a soap dispenser includes a housing and an actuator attached to the housing. The refill unit includes a container for holding a liquid and a pump in fluid communication with the container. The pump housing has one or more liquid inlets therethrough and one or more liquid outlets located through the housing. At least a portion of the liquid outlet is made of a resilient material. A liquid chamber is located at least partially within the housing. The liquid chamber has a first volume and a second volume. A valve body is located in the liquid chamber. The valve body has a protruding member and a valve seat. The protruding member acts as a one-way valve allowing fluid to flow from the container into the liquid chamber and preventing fluid from flowing out of the liquid chamber into the container. The valve seat contacts the liquid outlet, and the liquid outlet flexes away from the valve seat when the liquid chamber is pressurized to dispense liquid.

### BRIEF DESCRIPTION OF THE DRAWINGS

These and other features and advantages of the present invention will become better understood with regard to the following description, and accompanying drawings where:

FIG. 1 illustrates a double acting valve 100 with the inlet and outlet valves closed;

FIG. 2 illustrates the double acting valve of FIG. 1 having the outlet valve portion open;

FIG. 3 illustrates the double acting valve of FIG. 1 having the inlet valve portion open; and

FIG. 4 illustrates a dispenser and refill unit utilizing a liquid pump having a double acting valve.

### DETAILED DESCRIPTION

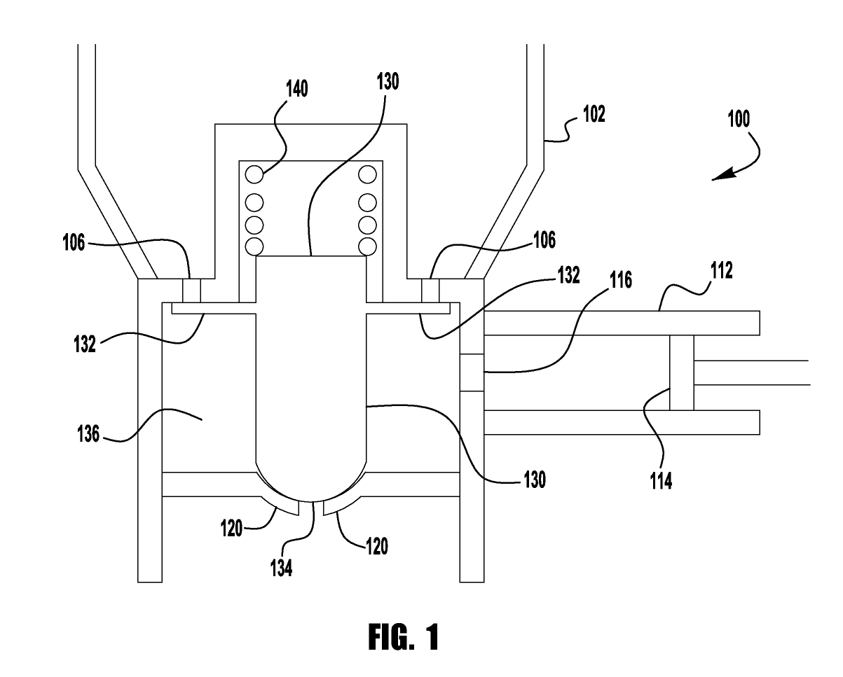

FIG. 1 illustrates an exemplary embodiment of a refill unit 100 having liquid pump 101. Liquid pump 101 has a housing 103. Housing 103 is connected to container 102 by a welded connection. Optionally, housing 103 may be connected to container 102 by other means, such as for example, by adhesive, a friction fit, a threaded connection, wherein a cap (not shown) is secured to housing 103 and is threaded onto threads (not shown) on a neck of container 102 or the like. Housing 103 includes one or more liquid inlets 106. Located at least partially within housing 103 is a liquid chamber 136. Liquid chamber 136 is in fluid communication with the interior of container 102 through the one or more liquid inlets 106. In this exemplary embodiment, a cylindrical sleeve 112 is secured to housing 103. Cylindrical sleeve 112 may be secured to housing 103 in any manner, and in one embodiment is integrally molded with housing 103. An opening 116 through housing 103 connects the interior of cylindrical sleeve 112 to the interior of housing 103, which also forms part of liquid chamber 136. A piston 114 is located in cylindrical sleeve 112. Piston 114 moves within cylindrical sleeve 112 and expands and contracts the volume of the liquid chamber 136.

Housing 103 includes outlet 110. Outlet 110 includes resilient member 120. Resilient member 120 may be made of any resilient material such as, for example, an elastomer, silicon, a polymer or the like. Resilient member 120 may be connected to housing 103 in any manner, such as for example, by an adhesive, sonic welding, etc. In one embodiment, resilient member 120 is integrally made with housing 103, and the material in the outlet area is thinner than the material in the rest of the housing 103 allowing resilient member 120 to flex during operation. Outlet 110 may be a circular outlet, or may have other shapes such as, for example, a slit, a star shape, an oval shape, etc.

A valve body 130 is located within housing 103. Valve body 130 includes a projecting member 132. In one embodiment, projecting member 132 is resilient and deflects downward when a negative pressure is created within liquid chamber 136. Projecting member 132 has an annular shape. Optionally, projecting member may have other shapes, and may be made up of one or more tabs. Valve body 130 includes a valve seat 134. The surface of valve seat 134 is curved; however, the surface maybe flat, tapered, conical, etc. In addition, optionally, a biasing member 140 may be provided. Biasing member 140 may be a spring, a clip, a sponge or any other member that exerts a downward force on valve body 130.

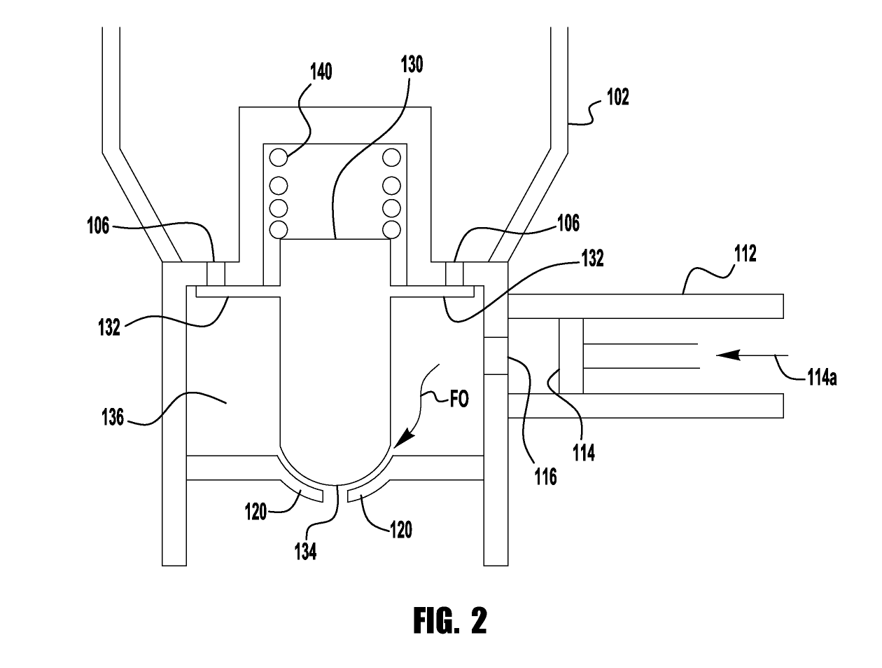

FIG. 2 illustrates the pump of FIG. 1 moving from a charged state (shown in FIG. 1) to an empty state. Piston 114 is moved in direction 114a reducing the volume of liquid chamber 136. As the volume is reduced, projecting member 132 seals against housing 103 and closes liquid inlet(s) 106. In addition, the pressure increases causing flexible member 120 to deflect away from valve seat 134 and liquid flows in direction FO out of outlet 110. Once piston 114 moves all the way in direction 114a, the pump 101 is empty and needs to be recharged. When the pressure in liquid chamber 136 is reduced, flexible member 120 seals against valve seat 134.

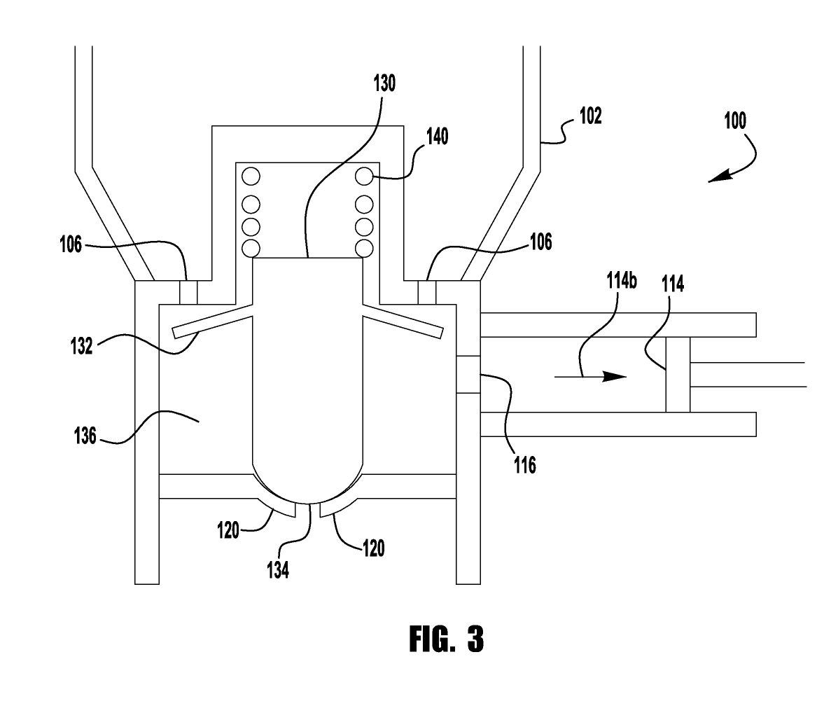

FIG. 3 illustrates the pump of FIG. 1 as it is being recharged. Piston 114 moves in direction 114b, which creates a vacuum in liquid chamber 136. Liquid outlet 110 is closed by valve seat 134 being in contact with flexible member 120. In one embodiment, biasing member 140 maintains a downward pressure on valve body 130 ensuring that the valve 130 remains closed. The vacuum pressure created in liquid chamber 136 causes liquid to flow in direction FI from container 102 through liquid inlets 106 into liquid chamber 136. When piston 114 moves all the way in direction 114b the pump 101 is charged.

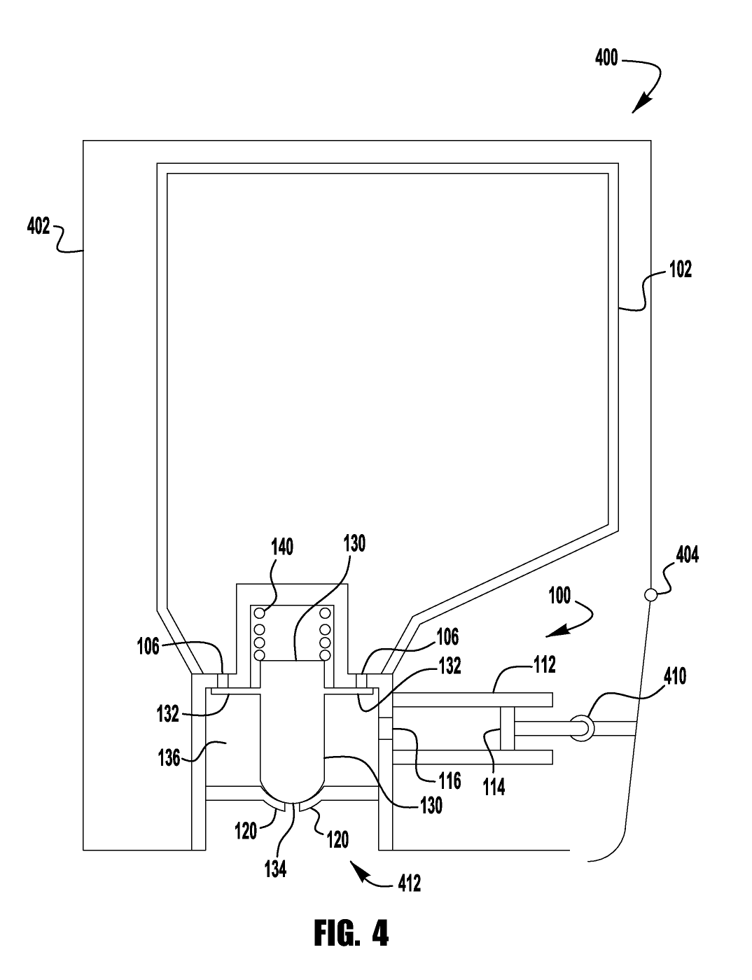

FIG. 4 illustrates the refill unit 100, comprising a pump 101 and container 102 in a dispenser 400. Dispenser 400 includes a housing 402. Housing 402 includes an actuator 406. Actuator 406 is connected to housing 402 by hinge 404. Actuator 406 may be pushed inward applying a horizontal force to piston 114. Actuator 406 connects to piston 114 through a connector 410. Moving actuator 406 in towards pump 101 causes the pump to dispense a shot of liquid. The actuator 406 is biased to an outward position by a biasing member (not shown), such as a spring. Piston 114 may be moved outward by virtue of being connected to actuator 406. Optionally, piston 114 may be moved outward by a biasing member (not shown) located inside of cylindrical sleeve 112. In such an embodiment, connector 410 may not be needed to connect to piston 114 as long as it is configured to apply a horizontal force to piston 114. In addition, the housing 402 includes an opening 412 through which liquid may be dispensed.

The embodiments described herein may all be used in liquid soap dispensers or foam dispensers. Such foam dispensers typically have a housing that may be mounted on a wall and have an actuating mechanism that actuates an air pump (not shown). A mixing chamber (not shown) would be located downstream of the outlet 110. The mixing chamber would include an air inlet to allow air to mix with the liquid. In addition, one or more porous members would be located downstream of the mixing chamber. The liquid and air mixture would be forced by the air pressure through the porous member and the mixture would be dispensed as a foam.

The actuating mechanism may be a manual actuator or an electronic actuator (not shown). An electronic actuator may be actuated by a sensor (not shown) that senses when a user's hand is in the dispensing area. Aspects of the various embodiments described herein may be used alone or in combination with all or portions of other embodiments described herein even though they are not specifically identified as being combinable with one another.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Still yet, the embodiments may be modified to pump and dispense a fluid, a particulate and air as a mixture or foam. Therefore, the invention, in its broader aspects, is not limited to the specific details, the representative apparatus and illustrative examples shown and described. Accordingly, departures may be made from such details without departing from the spirit or scope of the applicants' general inventive concept.

I/We claim:

1. A refill unit for a foam dispenser comprising:
a container for holding a liquid;
a pump in fluid communication with the container;
the pump comprising,
a housing;
one or more liquid inlets through the housing and in fluid communication with the container;
one or more liquid outlets located through the housing, wherein at least a portion of the liquid outlet is made of a resilient material;
a liquid chamber located at least partially within the housing, the liquid chamber having a first volume and a second volume;
a one-piece valve body having a protruding member and a valve seat;
wherein the protruding member acts as a one-way valve allowing fluid to flow from the container into the liquid chamber and preventing fluid from flowing out of the liquid chamber into the container; and
wherein the valve seat contacts the liquid outlet, and wherein the liquid outlet flexes away from the valve seat when the liquid chamber is pressurized to dispense liquid.

2. The refill unit of claim 1 further comprising a soap dispenser housing for receiving the refill unit and an actuator for causing the soap dispenser to dispense fluid from the refill unit.

3. The refill unit of claim 1 further comprising a piston for moving the liquid chamber between the first volume and the second volume.

4. The refill unit of claim 1 wherein the valve seat has a rounded surface.

5. The refill unit of claim 1 wherein the projection member has an annular shape.

6. The refill unit of claim 1 wherein the projection member comprises one or more tabs.

7. The refill unit of claim 1 further comprising a biasing member for biasing the valve seat against the outlet of the housing.

8. A liquid pump comprising:
a housing;
one or more liquid inlets through the housing;
a liquid chamber located within the housing;
the liquid chamber having a first volume and a second volume;
a liquid outlet;
the liquid outlet at least partially formed by a resilient material, wherein the resilient material is configured to deflect when the liquid chamber is pressurized and allows liquid to flow out of the housing;
a one-piece valve body located within the housing;
the valve body having a resilient projection located proximate the liquid inlets, wherein the resilient member prevents liquid from flowing out of the liquid chamber through the liquid inlets when there is a positive pressure in the liquid chamber; and
a valve seat, wherein the valve seat engages the resilient member of the liquid outlet when there is a negative pressure in the liquid chamber and the liquid outlet flexes away from the valve seat when the liquid chamber is pressurized to dispense liquid.

9. The liquid pump of claim 8 further comprising a piston for moving the liquid chamber between the first volume and the second volume.

10. The liquid pump of claim 8 wherein the valve seat has a rounded surface.

11. The liquid pump of claim 8 wherein the projection member has an annular shape.

12. The liquid pump of claim 8 wherein the projection member comprises one or more tabs.

13. The liquid pump of claim 8 further comprising a biasing member for biasing the valve seat against the outlet opening of the housing.

14. The liquid pump of claim 8 further comprising a container for holding a liquid, wherein the container is connected to the pump housing.

15. The liquid pump of claim 14 further comprising a dispenser and an actuator wherein movement of the actuator causes the liquid pump to move from a first volume to a second volume.

16. A soap dispenser and refill unit comprising:
a housing;
an actuator attached to the housing;
a container for holding a liquid retained within the housing;
a pump in fluid communication with the container;
the pump comprising,
a housing;
one or more liquid inlets through the housing and in fluid communication with the container;
one or more liquid outlets located through the housing, wherein at least a portion of the liquid outlet is made of a resilient material;
a liquid chamber located at least partially within the housing, the liquid chamber having a first volume and a second volume;
a one-piece valve body having a protruding member and a valve seat;
wherein the protruding member acts as a one-way valve allowing fluid to flow from the container into the liquid chamber and preventing fluid from flowing out of the liquid chamber into the container; and
wherein the liquid outlet contacts the valve seat to seal the outlet and flexes away from the valve seat to allow liquid under pressure to exit the liquid chamber.

17. The soap dispenser and refill unit of claim 16 further comprising a piston for moving the liquid chamber between the first volume and the second volume.

18. The refill unit of claim 16 wherein the valve seat has a rounded surface.

19. The refill unit of claim 16 wherein the projection member has an annular shape.

20. The refill unit of claim 16 further comprising a biasing member for biasing the valve seat against the outlet of the housing.
